(19) United States
(12) Patent Application Publication
(10) Pub. No.: US 2023/0007991 A1
(43) Pub. Date: Jan. 12, 2023

(54) WEARABLE DISPLAY APPARATUS AND DRIVING METHOD THEREOF

(71) Applicant: SEEYA OPTRONICS CO., LTD., Shanghai (CN)

(72) Inventor: Zhongshou HUANG, Shanghai (CN)

(73) Assignee: SEEYA OPTRONICS CO., LTD., Shanghai (CN)

(21) Appl. No.: 17/810,864

(22) Filed: Jul. 6, 2022

(30) Foreign Application Priority Data
Jul. 7, 2021 (CN) 202110768028.X

(51) Int. Cl. G02B 27/01

(52) U.S. Cl. CPC G02B 27/0172; G02B 2027/0174; G02B 2027/0187

(57) ABSTRACT

A wearable display apparatus includes a display unit, a light guide, a semi-transparent photodetector unit and a control unit. The semi-transparent photodetector unit periodically acquires the optical image which is given by the display unit and propagated through the light guide, and sends the acquired image data to the control unit for further processing. Drifts of the image characteristics with time are calculated and the corresponding compensations in brightness decay and color drift are applied to the display unit.

### CROSS-REFERENCE TO RELATED APPLICATION(S)

This application claims priority to Chinese Patent Application No. 202110768028.X filed Jul. 7, 2021, the disclosure of which is incorporated herein by reference in its entirety.

### TECHNICAL FIELD

The present disclosure relates to display technology and, in particular, to a wearable display apparatus and a driving method thereof.

### BACKGROUND

With the development of organic light-emitting diode (OLED) display technology and the expansion of the large-scale manufacturing industry, OLED displays have become the mainstream of mobile displays and contribute a considerable market share in medium-sized displays and even large-sized TV displays. When the OLED display technology is applied to some special applications, such as wearable augmented reality (AR) or virtual reality (VR), more compact and lighter weight display provides considerable advantages. Therefore, the miniaturization of the OLED display has become an obvious development trend for wearable AR or VR glasses.

In order to maintain a similar light intensity (the light intensity is defined as light flux per unit solid angle emitted from a display) while a display size shrinks, display brightness (the display brightness is defined as a light intensity per unit emission area) must be increases. However, increasing brightness in a miniaturized display body may inevitably create overheating risks. For instance, developing an efficient heat dissipation structure for a tiny 0.5″×0.5″ OLED chip that is embedded in the wearable AR/VR glasses has to tackle many tough technical challenges, to make things worse, a high image resolution, such as 4K image format, and a high fresh rate, such as 60 Hz, are become normal for today's high-end display applications, all these requirements may cause the OLED display working at a high temperature constantly.

As a display works at a relatively high temperature for a long time, the light-emitting materials, particularly the organic light-emitting materials employed in the OLED, will develop various problems that seriously affect image quality, such as a decay in luminescence efficiency, a color drift, afterimage or burn-in. Organic molecules electrically stressed in room temperature may gradually age and lose luminescence capability, a continuous high working temperature will certainly accelerate the aging process of the organic materials. The material aging decreases the overall luminescence efficiency in an OLED or vice versa increases power consumption for maintaining the same brightness. In addition, in an OLED display using red, green and blue (RGB) light-emitting materials to create color image, the light-emitting materials of different colors usually have different decay speed or lifetimes, one color may decay faster than another, the display image gradually deviates from its ideal white balance and tends to exhibit a color tint, which is referred to as a color cast. Therefore, it is necessary to provide a solution that can effectively tackle the problems of brightness decay and color drift in the AR/VR glasses caused by the aging phenomenon in the OLED so that to effectively prolong the lifetime of the display.

### SUMMARY

Embodiments of the present disclosure provide a wearable display apparatus and a driving method thereof. The wearable display apparatus has a capability of compensating for drifts of image characteristics including brightness decay and color drift during use, thereby improving the display performance and lifetime.

The wearable display apparatus includes a control unit, a display unit, a light transmission unit and a semi-transparent photodetector unit.

The display unit includes a plurality of light-emitting elements and is configured to output an optical image.

The light transmission unit is configured to pass a first part of the optical image to human eyes and a second part of the optical image to the semi-transparent photodetector unit respectively.

The semi-transparent photodetector unit includes a plurality of detection regions and a plurality of transparent regions, that a sum of areas of the transparent regions is greater than or equal to 30% and less than or equal to 90% of the area of the semi-transparent photodetector unit. Each detection region further includes a photosensor and a driving circuit, the plurality of transparent regions allow external light pass through and reach to the human eyes.

Based on a feedback signal from the semi-transparent photodetector unit, the control unit is configured to compensate for drifts of image characteristics including brightness decay and color drift.

The light transmission unit includes a light guide, a first reflector and a second reflector. The first reflector is configured to reflect the optical image into the light guide, the second reflector with reflectivity greater than or equal to 10% and less than or equal to 90% is configured to reflect the first part of the optical image to the human eyes and pass through the external lights.

The semi-transparent photodetector unit is attached to a surface of the second reflector facing towards or facing away from the human eyes through a first transparent medium layer.

The light transmission unit further includes an optical waveguide, an input coupler and an output coupler based on diffractive waveguide.

The optical waveguide is configured to propagate the optical image, the input coupler is configured to input the optical image into the optical waveguide, and the output coupler is configured to output the first part of the optical image to the human eyes and the second part of the optical image to the semi-transparent photodetector unit.

The semi-transparent photodetector unit is attached to a side of the output coupler through a second transparent medium layer.

Each of the input coupler and the output coupler includes a surface relief grating or a volume holographic grating.

The display unit includes an organic light-emitting display panel manufactured on a semiconductor silicon substrate.

The semi-transparent photodetector unit includes a plurality of sensors for sensing light intensity or for sensing color spectral or for sensing optical image.

The plurality of detection regions and the plurality of transparent regions are arranged periodically in space and formed in an array, that the number of the detection regions equals to the number of the transparent regions.

The sensors for sensing a same color are connected to one output signal line and read out by the control unit, or all the sensors are sequentially scanned and readout by the control unit.

The driving method for the preceding wearable display apparatus includes steps described below.

A display unit is controlled to output an optical image based on an initial image setting.

Image information is acquired periodically from the semi-transparent photodetector unit and is sent to the control unit.

The acquired image information is compared with the initial image setting, and the drifts of image characteristics including brightness decay and color drift are calculated.

Compensation for the drifts of image characteristics is performed for the optical image once the drifts exceed a preset threshold level.

The compensation step further includes: applying an linear interpolation algorithm to the space between two adjacent detection regions.

The display unit outputs the optical image; the light transmission unit passes the first part of the optical image to the human eyes so that the human can see the optical image and passes the second part of the optical image to the semi-transparent photodetector unit. The second part of the optical image is fed back to the control unit so that the image characteristics including brightness decay and color drift can be detected. The light transmission unit and the semi-transparent photodetector unit pass the external light to the human eyes so that the optical image of the display unit is superimposed with an external real image, achieving the AR display performance. The control unit has a capability of compensating for the drifts of the image characteristics including brightness decay and color drift, thereby improving the display performance and the lifetime of the device.

### BRIEF DESCRIPTION OF DRAWINGS

FIG. 1 is a structure view of a wearable display apparatus according to an embodiment of the present disclosure.

FIG. 2 is a top view of a semi-transparent photodetector unit according to an embodiment of the present disclosure.

FIG. 3 and FIG. 4 are each a structure view of another wearable display apparatus according to an embodiment of the present disclosure.

FIG. 5 and FIG. 6 are each a cross-sectional view of a semi-transparent photodetector unit according to an embodiment of the present disclosure.

FIG. 7 is a cross-sectional view of another semi-transparent photodetector unit according to an embodiment of the present disclosure.

FIG. 8 and FIG. 9 are each a structure view of another wearable display apparatus according to an embodiment of the present disclosure.

FIG. 10 to FIG. 12 are each a cross-sectional view of a semi-transparent photodetector unit according to an embodiment of the present disclosure.

FIG. 13 to FIG. 15 are each a schematic view illustrating a connection relationship of a semi-transparent photodetector unit according to an embodiment of the present disclosure.

FIG. 16 is a flowchart of a driving method for a wearable display apparatus according to an embodiment of the present disclosure.

FIG. 17 is a schematic diagram of a compensation method for roundness processing on a border region according to an embodiment of the present disclosure.

### DETAILED DESCRIPTION

The present disclosure is further described hereinafter in detail in conjunction with drawings and embodiments. It is to be understood that the embodiments described herein are intended to illustrate and not to limit the present disclosure. Additionally, it is to be noted that for ease of description, only part, not all, of the structures related to the present disclosure are illustrated in the drawings.

Terms used in embodiments of the present disclosure are intended merely to describe embodiments and not to limit the present disclosure. It is to be noted that nouns of locality such as “above”, “below”, “left” and “right” in the embodiments of the present disclosure are described from angles shown in the drawings and are not to be construed as limiting the embodiment of the present disclosure. Additionally, in the context, it is to be understood that when an element is formed “above” or “below” another element, the element can not only be directly formed “above” or “below” the other element but also be indirectly formed “above” or “below” the other element via an intermediate element. Terms such as “first” and “second” are used only for the purpose of description to distinguish between different components and not to indicate any order, quantity or importance. For those of ordinary skill in the art, specific meanings of the preceding terms in the present disclosure may be understood based on specific situations.

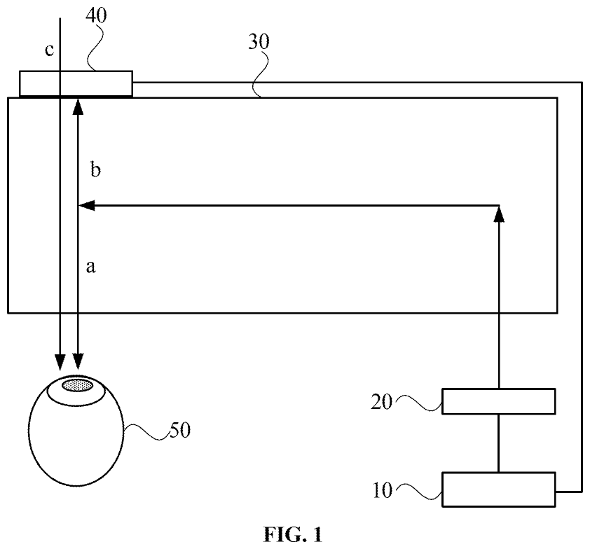

FIG. 1 is a structure view of a wearable display apparatus according to an embodiment of the present disclosure. Referring to FIG. 1, the wearable display apparatus provided in this embodiment includes a control unit 10, a display unit 20, a light transmission unit 30 and a semi-transparent photodetector unit 40. The display unit 20 includes multiple light-emitting elements (not shown in FIG. 1) and is configured to output an optical image. The light transmission unit 30 is configured to pass a first part a (light beam a) of the optical image to human eyes 50 and pass a second part b (light beam b) of the optical image to the semi-transparent photodetector unit 40. The semi-transparent photodetector unit 40 includes multiple detection regions and multiple transparent regions, that a sum of areas of the transparent regions is greater than or equal to 30% and less than or equal to 90% of the area of the semi-transparent photodetector unit 40, each of the detection regions further includes a photosensor and a driving circuit, the plurality of transparent regions allow external light beam c pass through and reach to the human eyes 50. The control unit is configured to, based on the feedback signal from the semi-transparent photodetector unit 40, compensate for drifts of image characteristics including brightness decay and color drift.

The wearable display apparatus provided in this embodiment may be an AR display. The control unit 10 may include an image processing chip and is configured to control the display unit 20 to output the optical image according to a preset program. According to the application scenario of the wearable display apparatus, the display image may be a static picture or a video image. The control unit 10, the display unit 20, the light transmission unit 30 and the semi-transparent photodetector unit 40 may be integrated into a housing such as a helmet. The light-emitting element may be an OLED. In some specific implementations, to reduce the volume of the display unit 20, the display unit 20 includes a silicon-based OLED display panel, where a pixel array and its driving circuit, row scan lines, data lines and external power supply lines are all integrated into a silicon chip, and an OLED thin film is deposited on the silicon chip through thin film evaporation or the like. The light transmission unit 30 includes necessary structures such as reflectors and a light guide to accommodate light propagation path. The light transmission unit 30 is configured to transmit light beam a to the human eyes 50, and transmit the light beam b to the semi-transparent photodetector unit 40 for sensing purpose. The semi-transparent photodetector unit 40 may include a plurality of photoelectric sensors and convert the light beam a into a real-time electrical signal. Information regarding the brightness decay and a color drift of the display unit 20 are extracted and fed back to the control unit 10. The control unit 10 adjusts a drive signal based on the feedback signal, so as to compensate for brightness decay and color drift. The photodetector unit 40 is capable of transmitting some external light, thereby achieving an AR display functionality. It is to be noted that light beam a and light beam b in FIG. 1 may not be the actual light propagating path, but only an illustrative representation of two optical image components from the display unit 20, and which are propagated into the human eyes 50 and the photodetector unit 40, respectively.

According to the technical solutions in the embodiment of the present disclosure, the display unit is controlled by the control unit and outputs the optical image; the light transmission unit passes the light beam a to the human eyes so that the human can see the optical image and the light beam b to the semi-transparent photodetector unit. The semi-transparent photodetector unit transmits a signal to the control unit, and the control unit compensates for drifts of image characteristics including brightness decay and the color drift based on the feedback signal, thereby improving the display performance and the lifetime. The external light beam c is propagated to the human eyes through the light transmission unit and the semi-transparent photodetector unit and is superimposed with the light beam a on the retina of the human eyes, thereby creating an AR visual perception.

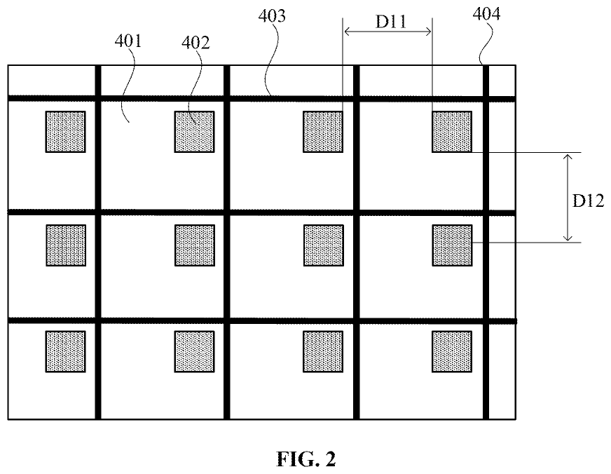

According to the embodiment of the present disclosure, the semi-transparent photodetector unit may include a plurality of detection region that each includes a photosensor and a driving circuit, and a plurality of transparent region that a sum of which occupies 30% to 90% area of the semi-transparent photodetector unit. This feature is further illustrated in FIG. 2.

FIG. 2 is a top view of a semi-transparent photodetector unit according to an embodiment of the present disclosure, which includes a plurality of transparent regions 401 and a plurality of detection regions 402. Each detection region includes a photosensor and the associated driving circuit (whose specific structures are not shown in FIG. 2). The semi-transparent photodetector unit further includes first wires 403 and second wires 404, which are configured to transmit control signals and data signals, into and out of the semi-transparent photodetector unit, respectively. The sum of the areas of the transparent regions is configured to be 30% to 90% of the entire area of the semi-transparent photodetector unit, to ensure a sufficient transmittance in the semi-transparent photodetector unit for the external light.

Optionally, the detection regions 402 and the transparent regions 401 are arranged periodically in space and formed in an array, all adjacent detection regions 402 have the same distance, and the number of the detection regions 402 substantially equals to the number of the transparent regions 401.

In some specific implementations, to avoid Moire fringes resulting from periodically sampling on an array, a horizontal detection pitch D11 and a vertical detection pitch D12 are made not less than a pixel pitch of an image propagated from the display unit and projected on a plane of the photoelectric sensor, and made twice bigger than a distance between two adjacent grids on an output coupling grating. The first wires 403 (control lines) and the second wires 404 (data lines) are disposed between photoelectric sensors. These data lines and control lines may be made of a metal or a transparent conductive material such as indium tin oxide (ITO). Metal wires made of aluminum alloy or copper or chromium or molybdenum have very low resistivity and thus even at 0.5 microns to 2 microns thick can be made very narrow to increase light transmittance of the semi-transparent photodetector unit. On the other hand, though ITO has relatively high resistivity such as 10 ohms per square, much a much wider ITO strip even it covers the entire transparent regions, can be utilized without sacrificing transmittance too much. In addition, monochrome filter or filters of different colors, such as R, G, B, may be added on the photosensors to capture spatial distribution of colors.

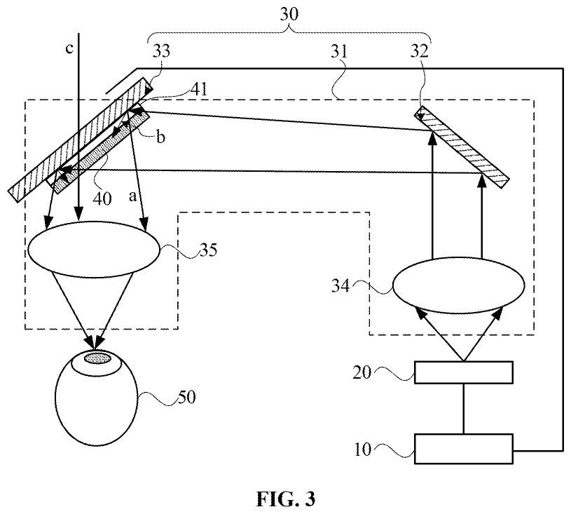

FIG. 3 and FIG. 4 are each a structure view of another wearable display apparatus according to an embodiment of the present disclosure. Referring to FIG. 3 or FIG. 4, the light transmission unit 30 includes a light guide 31, a first reflector 32 and a second reflector 33. The first reflector 32 is configured to reflect the optical image into the light guide 31, the second reflector 33 is configured to reflect the light beam a to the human eyes and transmit external light beam c. The second reflector 33 has a reflectivity from 10% to 90% and a transmittance from 10% to 90%.

The first reflector 32 and the second reflector 33 may be a simple reflective mirror, or configured with other optical devices such as a prism. In this embodiment, the second reflector 33 is a beam splitter that is partially reflective and partially transmissive. Referring to FIG. 3, the semi-transparent photodetector unit 40 is attached to a surface of the second reflector 33 facing towards the human eyes 50 through a first transparent medium layer 41. Alternatively, referring to FIG. 4, the semi-transparent photodetector unit 40 is attached to a surface of the second reflector 33 facing away from the human eyes 50 through the first transparent medium layer 41.

Optionally, the refractive index of the first transparent medium layer 41 is made essentially between that of the second reflector 33 and that of the semi-transparent photodetector unit 40, thereby improving the light transmittance from the second reflector 33 to the semi-transparent photodetector unit 40.

During operation of the wearable display apparatus, a real-time electrical signal from the semi-transparent photodetector unit 40 is passed to the control unit 10 through a signal line. The control unit 10 then analyzes and compares the real-time electrical signal with its initial image signal in order to extract the information regarding the brightness decay and color drift, and even to predict a successive brightness decay and color drift following the real-time data trend. Based on the prediction, if needed, the control unit may perform a kind of over-correction on the real time data.

According to the calculated brightness decay and color drift, the control unit 10 adds a compensation signal on the initial image signal to form an updated image signal, which can be a simple addition or subtraction or a little complicated non-linear modification, to the initial image signal. The compensation signal may be created according to actual situations and requirements in some specific implementations. After inputting the updated image signal into the display unit 20, the optical image from the display may be restored to its original status prior to the brightness decay or the color drift.

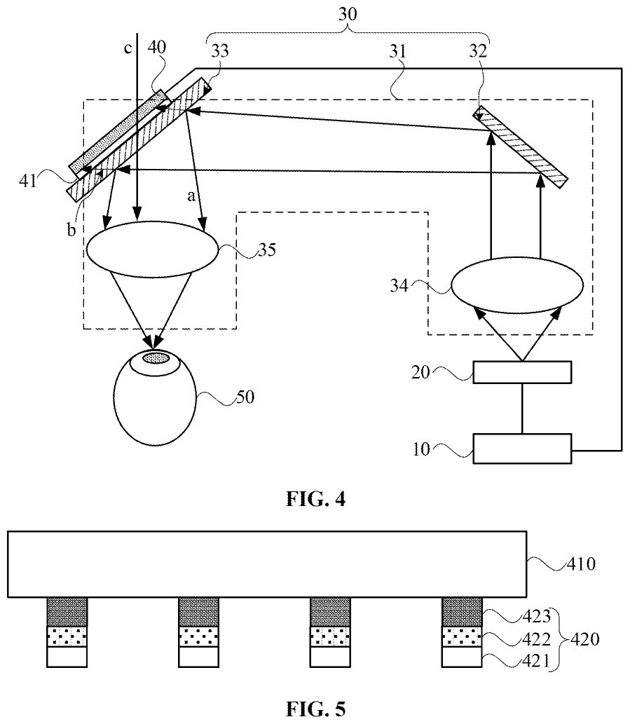

FIG. 5 and FIG. 6 are each a sectional view of a semi-transparent photodetector unit according to an embodiment of the present disclosure. Referring to FIGS. 5 and 6, the semi-transparent photodetector unit includes a transparent substrate 410 and a photoelectric sensor 420 on a side of the transparent substrate 410. The photoelectric sensor 420 includes a transparent electrode 421, a semiconductor film 422 and an opaque electrode 423, and the opaque electrode 423 is disposed on a side of a photosensitive surface of the photoelectric detector 420 facing away from a reflective mirror of the second reflector. The semi-transparent photodetector unit illustrated in FIG. 5 is used in the embodiment of FIG. 4, where the opaque electrode 423 is disposed above the semiconductor film 422 and the semi-transparent photodetector unit is disposed above the beam splitter. The semi-transparent photodetector unit illustrated in FIG. 6 is used in the embodiment of FIG. 3, where the opaque electrode 423 is disposed below the semiconductor film 422 and the photodetector unit is disposed below the beam splitter.

Optionally, the photoelectric detector is a bidirectional photodetector.

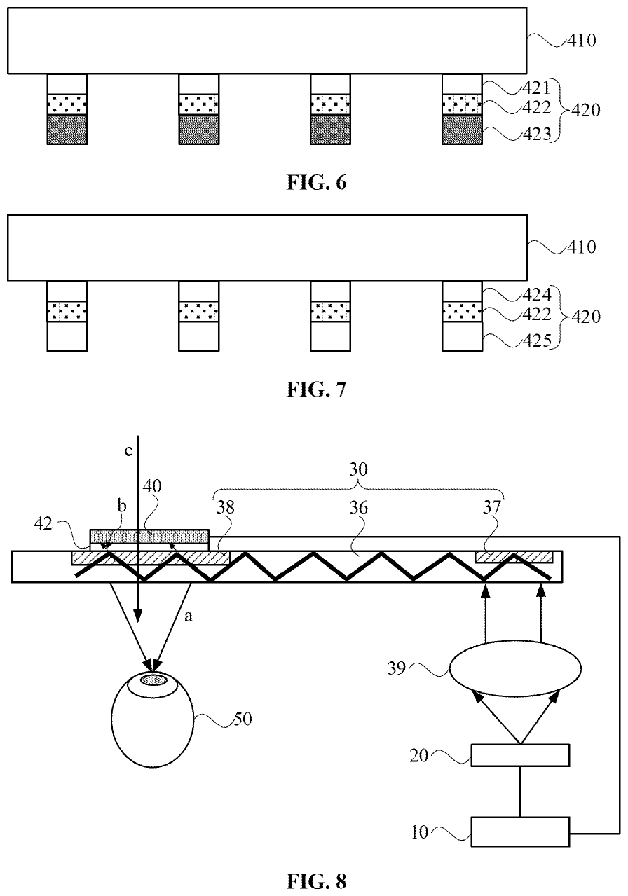

FIG. 7 is a sectional view of another semi-transparent photodetector unit according to an embodiment of the present disclosure. The semi-transparent photodetector unit includes the transparent substrate 410 and the photoelectric sensor 420 disposed on the side of the transparent substrate 410. The photoelectric sensor 420 includes a first transparent electrode 424, the semiconductor film 422 and a second transparent electrode 425. In other words, the photoelectric detector is the bidirectional photodetector which senses light incident from two directions. The detectors in FIG. 6 and in FIG. 7 normally respond to both the external light and the internal light from the display unit, but can be configured to response only the external light by turning off the display unit in a time slot. The photoelectric response of the display unit can be obtained by subtracting the external photoelectric response from overall response. In addition, the transparent substrate 410 may be rigid such as a glass substrate, or may be flexible such as an ultra-thin glass substrate or a transparent substrate containing polymer or resin. Since a glass lens of the wearable display apparatus may have a curved surface for vision correction or transverse transmission of light from the display unit 20 inside the glass lens, an array of photoelectric sensor units fabricated on a flexible substrate may be attached to a surface of a curved lens directly or through an optically clear adhesive.

Still referring to FIG. 3 and FIG. 4, the light transmission unit 30 further includes a focusing lens 34 between the display unit 20 and the first reflector 32, and an eyepiece 35 between the human eyes 50 and one of the second reflector 33 or beam splitter, respectively.

The focusing lens 34 is configured to collimate the light from the display unit 20, and the eyepiece 35 is configured to converge light into the human eyes 50. In some specific implementations, the focusing lens 34 and the eyepiece 35 may each adopt a lens combination including a plurality of lenses to improve an imaging performance.

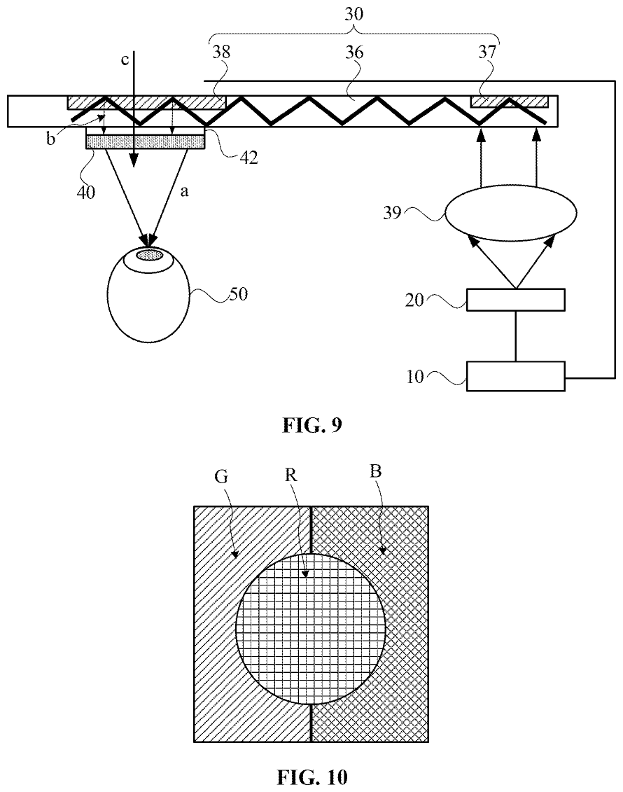

FIG. 8 and FIG. 9 are each a structure view of another wearable display apparatus according to an embodiment of the present disclosure. Referring to FIG. 8 or FIG. 9, the light transmission unit 30 further includes an optical waveguide 36 (only one optical waveguide is illustrated in FIGS. 8 and 9) for propagating the optical image, an input coupler 37 for inputting the optical image into the optical waveguide 36, and an output coupler 38 for outputting the light beam a to the human eyes 50 and the light beam b to the semi-transparent photodetector unit 40; and the semi-transparent photodetector unit 40 is attached to a side of the output coupler 38 through a second transparent medium layer 42 (FIG. 8 illustrates that the semi-transparent photodetector unit 40 is disposed on a side of the output coupler 38 facing away from the human eyes and FIG. 9 illustrates that the semi-transparent photodetector unit 40 is disposed on a side of the output coupler 38 facing towards the human eyes 50).

The input coupler 37 is disposed on an incident window of the optical waveguide 36, and the output coupler 38 is disposed on an output window of the optical waveguide 36. Optionally, each of the input coupler 37 and the output coupler 38 includes a surface relief grating (SRG) or a volume holographic grating (VHG). A waveguide using such a planar diffraction grating is also referred to as a diffraction waveguide, which differs from a geometrical optical waveguide depending on a total reflection at an interface between a high refractive index medium and a low refractive index medium. Through the input coupler 37, the optical image is propagated forward along the waveguide at a propagation angle greater than a total reflection angle on the interfaces of the optical waveguide 36. The output coupler 38 laterally projects the optical image onto retinae of the human eyes 50. In other embodiments, to reduce a rainbow effect, in other words, a color separation phenomenon caused by wavelength-dependent refractive indexes in a clear medium, three independent waveguides may be used for respectively transmitting R, G, and B light. It is to be understood that since the optical waveguide 36 is disposed between the output coupler 38 and the human eye, the semi-transparent photodetector unit 40 is attached to a surface of the optical waveguide 36 in practice.

In this embodiment, the output coupler 38 may output the light beam b. For example, in the embodiment of FIG. 8, when the output coupler 38 is the SRG, the output coupler 38 has a periodic concave-convex structure covering the surface of the optical waveguide 36, where a period thereof is smaller than a wavelength of the light. The laterally propagated light is diffracted a plurality of times on the output coupler, reflected diffraction waves enter the human eye, and transmitted diffraction waves enter the semi-transparent photodetector unit 40. A structure of the diffraction grating, such as a concave-convex degree of a surface of the grating, an inclination angle of a convex wall, a repetition period, a duty cycle or an arrangement angle of the grating on the surface of the optical waveguide, is adjusted so that different ratios in intensity of the reflected diffraction waves to the transmitted diffraction waves can be obtained. The semi-transparent photodetector unit 40 may adopt a semiconductor sensor with high sensitivity, such as a silicon photoelectric diode or a silicon complementary metal-oxide-semiconductor (CMOS) image sensor, so that sufficient information can be obtained based on only 1% to 10% of the laterally propagated light and an output light intensity and color drift of the display unit 20 can be calculated. This ensures that most light enters the human eyes 50 and the semi-transparent photodetector unit 40 has a sufficiently large signal. In the embodiment of FIG. 9, part of light from the output coupler 38 is directly incident on the semi-transparent photodetector unit 40. In addition, the output coupler 38 and the semi-transparent photodetector unit 40 have certain light transmittance and can transmit the external light beam to the human eye, achieving the AR display performance.

Optionally, the refractive index of the second transparent medium layer 42 is made essentially between that of the output coupler 38 and that of the semi-transparent photodetector unit 40. In some specific implementations, the second transparent medium layer 42 may be a resin-based thin film so that a diffraction performance of light in the diffraction grating is hardly affected, and the light beam b is easy to be transmitted to the semi-transparent photodetector unit 40.

Still referring to FIG. 8 or FIG. 9, the light transmission unit 30 further includes a focusing lens 39 between the display unit 20 and the input coupler 37.

The focusing lens 39 is configured to collimate the light from the display unit 20. In some specific implementations, the focusing lens 39 may adopt a lens combination including a plurality of lenses to improve an imaging performance.

In the embodiments of the present disclosure, a type of the photoelectric sensor used in the semi-transparent photodetector unit 40 may be selected according to actual requirements. Optionally, the semi-transparent photodetector unit includes a plurality of sensors for sensing light intensity or for sensing color spectral or for sensing optical image.

A black and white photoelectric detector which is selected for sensing light intensity and detects only the light intensity instead of distinguishing emitted colors of the light-emitting elements and may be used for brightness measurement. The color image sensor which is selected for sensing color spectral or optical image may adopt a CMOS or charge-coupled device (CCD) sensor. When the color cast needs to be measured, the multispectral photoelectric sensor or an image sensor in the plurality of sensors may be used.

Optionally, the semi-transparent photodetector unit includes the multispectral photoelectric sensor or the color image sensor; and the semi-transparent photodetector unit includes three detection regions for respectively detecting R, G, and B light.

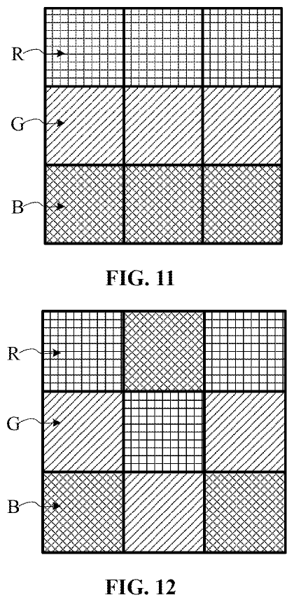

Exemplarily, FIG. 10 to FIG. 12 are each a plan view of a semi-transparent photodetector unit according to an embodiment of the present disclosure. Referring to FIG. 10 to FIG. 12, the semi-transparent photodetector unit includes a red detection region R, a green detection region G and a blue detection region B for detecting light of red, green and blue, respectively. In other embodiments, the three detection regions may also be arranged in other manners, which is not limited in the embodiment of the present disclosure.

Optionally, detection regions for sensing the same color are connected to one signal line and read out by the control unit, each detection region is connected to the control unit via a respective signal line, or all detection regions are sequentially scanned and read out by the control unit.

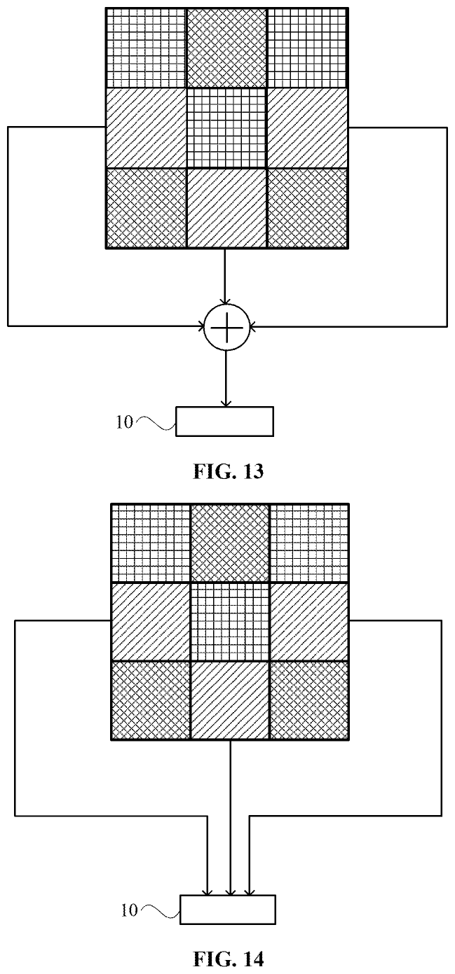

Exemplarily, FIG. 13 to FIG. 15 are each a schematic view illustrating a connection relationship of a semi-transparent photodetector unit according to an embodiment of the present disclosure. Each detection region includes a plurality of detection sub-regions (FIGS. 13 and 14 illustratively show that each detection region includes three detection sub-regions, and FIG. 15 shows that each detection region includes 12 detection sub-regions, which are not to limit the embodiments of the present disclosure), and each figure shows only one type of connection line for the detection regions. Referring to FIG. 13, all detection sub-regions for sensing the same color are connected to one output signal line and read out by the control unit 10 so that the number of connection lines is reduced and a circuit is simplified. Referring to FIG. 14, each detection sub-region is connected to the control unit 10 via a respective signal line so that measurement accuracy can be improved, which is applicable to the case where relatively few detection regions are included. Referring to FIG. 15, the semi-transparent photodetector unit includes a scan unit 405 and a preprocessing unit 406. The preprocessing unit 406 may include a pre-amplifier and an analog-to-digital converter, and all detection sub-regions are sequentially scanned and read out by the control unit 10 through the preprocessing unit 406, which is applicable to the case where the photoelectric sensors are arranged at a relatively high density and can measure light emission characteristics of the display unit with high accuracy.

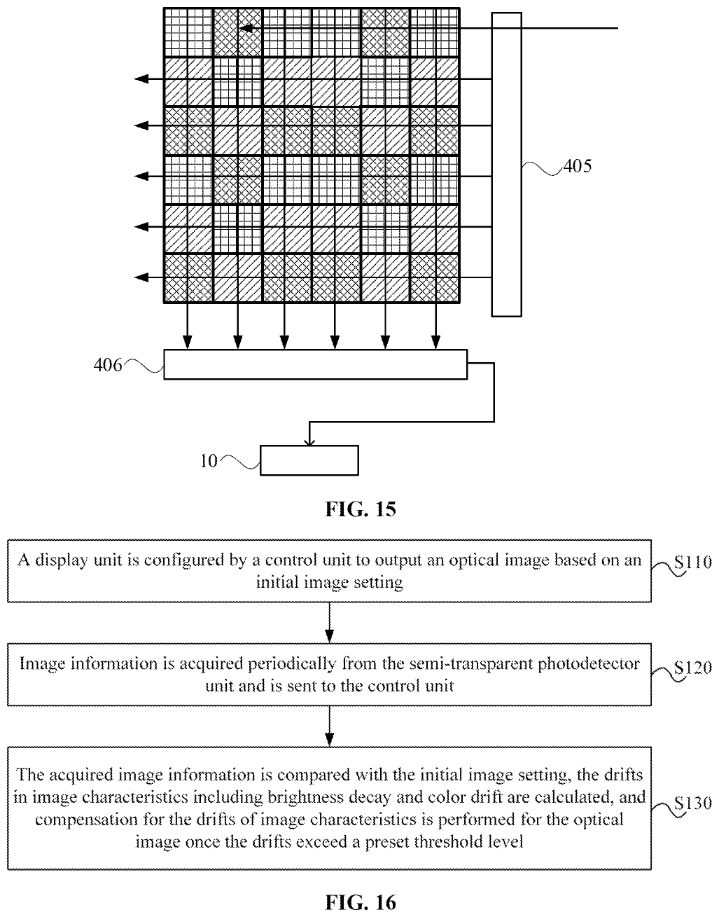

FIG. 16 is a flowchart of a driving method for a wearable display apparatus according to an embodiment of the present disclosure. The driving method is applicable to any wearable display apparatus provided in the preceding embodiments. Referring to FIG. 16, the driving method includes steps described below.

In step S110, a display unit is controlled by a control unit to output an optical image based on an initial image setting.

The control unit may include an image processing chip and is configured to control the display unit to output the optical image according to a preset program. The display unit may include an organic light-emitting display panel manufactured on a semiconductor silicon substrate, so as to adapt to the requirement of the wearable display apparatus for a small volume.

In step S120, image information is acquired periodically from the semi-transparent photodetector unit and is sent to the control unit.

The period may be set according to a usage situation of the wearable display apparatus, for example, may be one day, two days, a few hours or the like. The photodetector unit converts an optical signal into a real-time electrical signal and feeds the real-time electrical signal back to the control unit.

In step S130, the acquired image information is compared with the initial image setting, the drifts in image characteristics including brightness decay and color drift are calculated, and compensation for the drifts of image characteristics is performed for the optical image once the drifts exceed a preset threshold level.

The preset threshold value may be set according to actual situations, for example, a brightness decay exceeds a preset percentage, a color coordinate drift exceeds a preset value, or the like, which may be designed according to the actual situations in some specific implementations.

According to the technical solutions in the embodiment of the present disclosure, the control unit controls the display unit to output the optical image based on the initial image setting; the semi-transparent photodetector unit acquires the information about the image being displayed and feeds the information back to the control unit periodically; a light transmission unit and the semi-transparent photodetector unit transmit external light beam to human eyes so that the optical image of the display unit is superimposed with an external real image, achieving an AR display performance; and the control unit compares the acquired image information with the initial image setting, calculates the drifts of the image characteristics including brightness decay and color drift, and compensates for drifts of the image characteristics once the drifts exceed the preset threshold value, thereby improving the display performance of the wearable display apparatus and user experience.

Optionally, the control unit has the capability of compensating for drifts of the image characteristics including brightness decay and color drift by changing a driving current for the light-emitting element.

When the light-emitting element is an OLED that is current-driven, the drive current is changed so that light emission characteristics of the OLED can be changed. Specifically, according to the calculated brightness decay and color drift, the control unit adds a compensation signal component, for example, a simple addition or subtraction or a more complicated non-linear modification, to an image signal to be inputted into the display unit, which may be set according to actual situations and requirements in some specific implementations. In this manner, after an updated electrical image signal is inputted into the display unit, an optical image outputted again is restored to a state before the brightness decay or a color cast. In another embodiment, when brightness decay or the color drift is compensated for, an appropriate overcompensation manner may also be used, so as to avoid too high a compensation frequency.

Optionally, the compensation step further includes: applying a linear interpolation algorithm to the space between two adjacent detection regions.

It is to be understood that some pixels adjacent to each other may be located at a border of a detection region or a border of a detection sub-region, and when two detection regions or detection sub-regions are differently compensated for, abnormal display may occur at the border so that the roundness processing may be performed to compensate for pixels in the detection region or at the border of the detection region, so as to avoid the abnormal display.

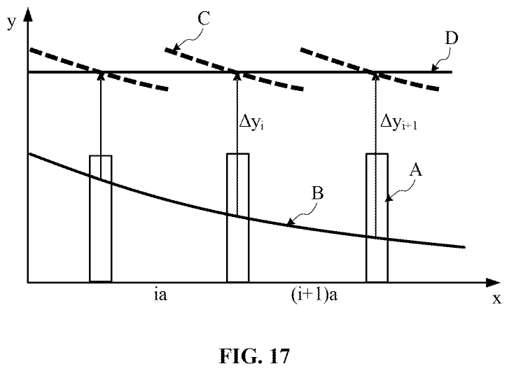

Exemplarily, FIG. 17 is a schematic diagram of a compensation method for roundness processing on a border region according to an embodiment of the present disclosure. In FIG. 17, an x-axis represents a spatial distance, and a y-axis represents a certain characteristic of an image, such as brightness here. Referring to FIG. 17, block A represents a detection region of the photodetector unit. For a plurality of pixels, curve B represents a brightness change curve along the x-axis after the brightness decay, and curve C represents a brightness curve after direct compensation. Due to a limited number of separate detection regions, a brightness jump may occur in the vicinity of a border between adjacent regions. Therefore, the roundness processing is performed on the brightness of all display pixels of the image. The following is one manner of the roundness processing. A change gradient of an i-th detection region is set:

$$tan {θ}_{i} = \frac{{Δ y}_{i + 1} - Δ y}{a} ;$$

A continuous compensation function is expressed as follows:

Y(x)=Δyᵢ+tan θᵢ[(i+0.5)a−x], ia≤x≤(i+1)a;

Curve D after the roundness processing is obtained, achieving uniform display. It is to be noted that in addition to the preceding linear interpolation, data filling may also be performed through non-linear interpolation and extrapolation. Moreover, such compensation may also be performed by the same method on other image characteristics including color drift in addition to the brightness decay.

It is to be noted that the above are only preferred embodiments of the present disclosure and technical principles used therein. It is to be understood by those skilled in the art that the present disclosure is not limited to the embodiments described herein. Those skilled in the art can make various apparent modifications, adaptations, combinations and substitutions without departing from the scope of the present disclosure. Therefore, while the present disclosure has been described in detail through the preceding embodiments, the present disclosure is not limited to the preceding embodiments and may include more other equivalent embodiments without departing from the concept of the present disclosure. The scope of the present disclosure is determined by the scope of the appended claims.

What is claimed is:

1. A wearable display apparatus, comprising a control unit, a display unit, a light transmission unit and a semi-transparent photodetector unit; wherein
the display unit comprises a plurality of light-emitting elements and is configured to output an optical image;
the light transmission unit is configured to pass a first part of the optical image to human eyes and a second part of the optical image to the semi-transparent photodetector unit respectively;
the semi-transparent photodetector unit comprises a plurality of detection regions and a plurality of transparent regions, that a sum of areas of the transparent regions is greater than or equal to 30% and less than or equal to 90% of the area of the semi-transparent photodetector unit, wherein each of the plurality of detection regions further comprises a photosensor and a driving circuit, the plurality of transparent regions allow external light pass through and reach to the human eyes; and
based on a feedback signal from the semi-transparent photodetector unit, the control unit is configured to compensate for drifts of image characteristics including brightness decay and color drift.

2. The wearable display apparatus according to claim 1, wherein the light transmission unit comprises a light guide, a first reflector and a second reflector, wherein the first reflector is configured to reflect the optical image into the light guide, the second reflector with reflectivity greater than or equal to 10% and less than or equal to 90% is configured to reflect the first part of the optical image to the human eyes and pass through the external light.

3. The wearable display apparatus according to claim 1, wherein the light transmission unit further comprises an optical waveguide, an input coupler and an output coupler based on diffractive waveguide, wherein
the optical waveguide is configured to propagate the optical image, the input coupler is configured to input the optical image into the optical waveguide, and the output coupler is configured to output the first part of the optical image to the human eyes and the second part of the optical image to the semi-transparent photodetector unit;
wherein the semi-transparent photodetector unit is attached to a side of the output coupler through a second transparent medium layer.

4. The wearable display apparatus according to claim 3, wherein each of the input coupler and the output coupler comprises a surface relief grating or a volume holographic grating.

5. The wearable display apparatus according to claim 1, wherein the display unit comprises an organic light-emitting display panel manufactured on a semiconductor silicon substrate.

6. The wearable display apparatus according to claim 1, wherein the semi-transparent photodetector unit comprise a plurality of sensors for sensing light intensity or for sensing color spectral or for sensing optical image.

7. The wearable display apparatus according to claim 1, wherein the plurality of detection regions and the plurality of transparent regions are arranged periodically in space and formed in an array, that the number of the detection regions equals to the number of the transparent regions.

8. The wearable display apparatus according to claim 6, wherein the sensors for sensing a same color are connected to one output signal line and read out by the control unit, or all the sensors are sequentially scanned and readout by the control unit.

9. A driving method for the wearable display apparatus according to claim 1, comprising the following steps:
controlling the display unit to output the optical image based on an initial image setting;
acquiring image information periodically from the semi-transparent photodetector unit and sending the acquired image information into the control unit;
comparing the acquired image information with the initial image setting and calculating the drifts of image characteristics including brightness decay and color drift;
performing compensation for the drifts of the image characteristics for the optical image once the drifts exceed a preset threshold level.

10. The driving method according to claim 9, wherein the compensation step further comprising:
applying an linear interpolation algorithm to the space between two adjacent detection regions.
